(19) United States
(12) Patent Application Publication
(10) Pub. No.: US 2013/0103723 A1
(43) Pub. Date: Apr. 25, 2013

(54) INFORMATION PROCESSING APPARATUS, INFORMATION PROCESSING METHOD, PROGRAM, AND RECORDING MEDIUM

(71) Applicant: Katsuya Hori, Kanagawa (JP)

(72) Inventor: Katsuya Hori, Kanagawa (JP)

(73) Assignee: Sony Corporation, Tokyo (JP)

(21) Appl. No.: 13/614,166

(22) Filed: Sep. 13, 2012

(30) Foreign Application Priority Data
Oct. 20, 2011 (JP) 2011-230983

(51) Int. Cl. G06F 17/30

(52) U.S. Cl. 707/803; 707/E17.005

(57) ABSTRACT

A system for creating files that includes at least one processor configured to identify, while a file is being created, a plurality of locations within the file, the plurality of locations including a first location within the file and a second location within the file different from the first location; acquire first tag information for the first location within the file and second tag information for the second location within the file; and associate the first tag information with the first location within the file and the second tag information with the second location within the file.

### BACKGROUND

The present disclosure relates to an information processing apparatus, an information processing method, a program, and a recording medium.

For tag information assigned to a content file such as a document, an image, or an audio, there are used time tag information and position tag information. For example, as for document files, pieces of time tag information indicating time at which the file is created, updated, and accessed are generally assigned to each file. Further, as for image files, there are some of the files to which position tag information of the capturing location can be assigned.

For example, JP 2004-32129A discloses a diary service providing server, the diary service being capable of displaying an image with a sentence as well as a capturing date/time and a capturing location which are stored as tag information.

### SUMMARY

In some embodiments, a system for creating files is disclosed. The system comprises at least one processor configured to identify, while a file is being created, a plurality of locations within the file, the plurality of locations including a first location within the file and a second location within the file different from the first location. The at least one processor is further configured to acquire first tag information for the first location within the file and second tag information for the second location within the file; and associate the first tag information with the first location within the file and the second tag information with the second location within the file.

In some embodiments, a method for creating files is disclosed. The method comprises identifying by using at least one processor, while a file is being created, a plurality of locations within the file, the plurality of locations including a first location within the file and a second location within the file different from the first location; acquiring first tag information for the first location within the file and second tag information for the second location within the file; and associating the first tag information with the first location within the file and the second tag information with the second location within the file.

In some embodiments, at least one computer-readable storage medium is disclosed. The at least one computer-readable storage medium stores processor-executable instructions that, when executed by at least one processor, cause the at least one processor to perform a method comprising: identifying, while a file is being created, a plurality of locations within the file, the plurality of locations including a first location within the file and a second location within the file different from the first location; acquiring first tag information for the first location within the file and second tag information for the second location within the file; and associating the first tag information with the first location within the file and the second tag information with the second location within the file.

### BRIEF DESCRIPTION OF THE DRAWINGS

FIG. 1 is a block diagram showing a functional configuration of a document creation device according to a first embodiment of the present disclosure;

FIG. 2 is an explanatory diagram showing an example of a document file created by the document creation device according to the embodiment;

FIG. 3 is a table showing examples of break positions detected by the document creation device according to the embodiment;

FIG. 4 is a table showing examples of items included in association information generated by the document creation device according to the embodiment;

FIG. 5 is an explanatory diagram showing an example of an association information file generated by the document creation device according to the embodiment;

FIG. 6 is an explanatory diagram showing an example of a display screen displayed by the document creation device according to the embodiment, which is for indicating positions having tags assigned thereto on sentences;

FIG. 7 is an explanatory diagram showing an example of tag information which is displayed when an operation is performed on the display screen of FIG. 6;

FIG. 8 is an explanatory diagram showing an example of the display screen displayed by the document creation device according to the embodiment, which is for indicating positions having the tags assigned thereto on the sentences when words are set as break positions;

FIG. 9 is an explanatory diagram showing an example of the tag information which is displayed when an operation is performed on the display screen of FIG. 8;

FIG. 10 is an explanatory diagram showing an example of a display screen in which tag information and sentences are displayed on a map by the document creation device according to the embodiment;

FIG. 11 is an explanatory diagram showing an example of a display screen in which tag information and sentences are displayed on a calendar by the document creation device according to the embodiment;

FIG. 12 is a flowchart showing an operation example of the document creation device according to the embodiment;

FIG. 13 is a block diagram showing a functional configuration of an audio recording device according to a second embodiment of the present disclosure;

FIG. 14 is an explanatory diagram showing an example of a display screen displayed by the audio recording device according to the embodiment, which is for indicating a position having a tag during audio recording assigned thereto;

FIG. 15 is an explanatory diagram showing a state when an operation is performed on the display screen of FIG. 14;

FIG. 16 is a flowchart showing an operation example of the audio recording device according to the embodiment;

FIG. 17 is a block diagram showing a functional configuration of an output control device according to a third embodiment of the present disclosure; and

FIG. 18 is a block diagram showing a hardware configuration example of tag information-assignment devices and the output control device according to the embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the description will be given in the following order.

1. First embodiment (Example of assigning tag information to document file)
1-1. Functional configuration
1-2. Example of display screen
1-3. Operation

2. Second embodiment (Example of assigning tag information to audio file)
2-1. Functional configuration
2-2. Example of display screen
2-3. Operation

3. Third embodiment (output control device)

4. Example of hardware configuration

### 1. First Embodiment

### Example of Assigning Tag Information to Document File

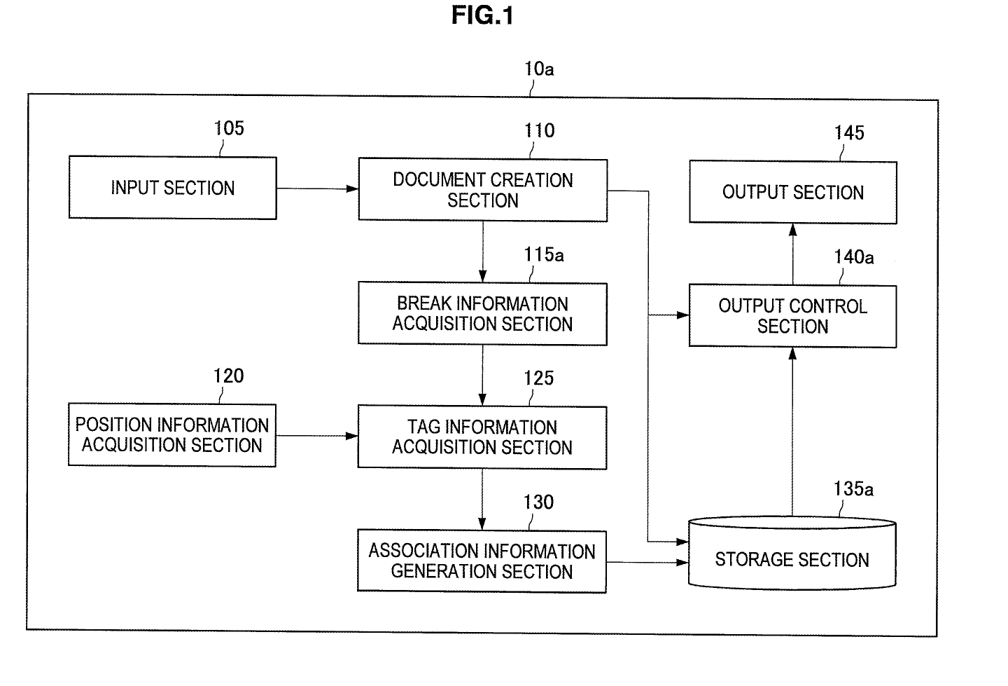

First, with reference to FIGS. 1 to 14, there will be described a document creation device according to a first embodiment of the present disclosure. The document creation device to be described here is an example of an information processing apparatus according to the present disclosure, and is an example of a tag information-assignment device that assigns tag information to a document file.

[1-1. Functional Configuration]

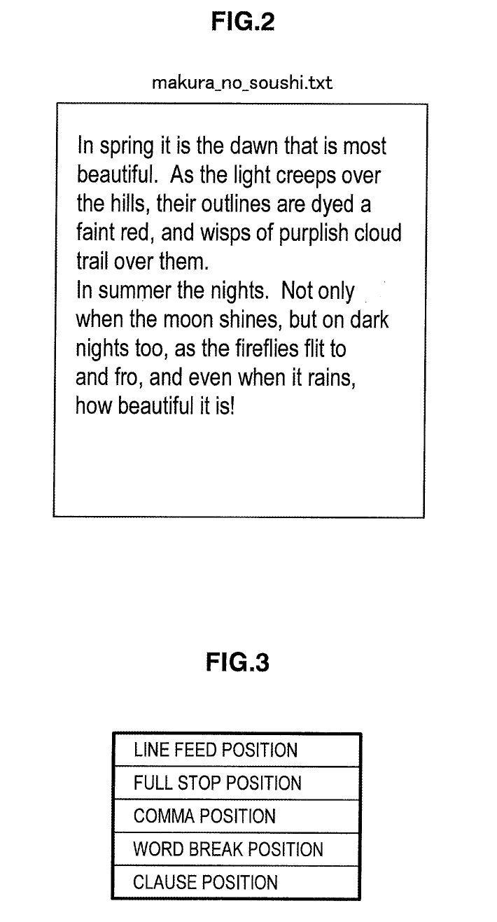

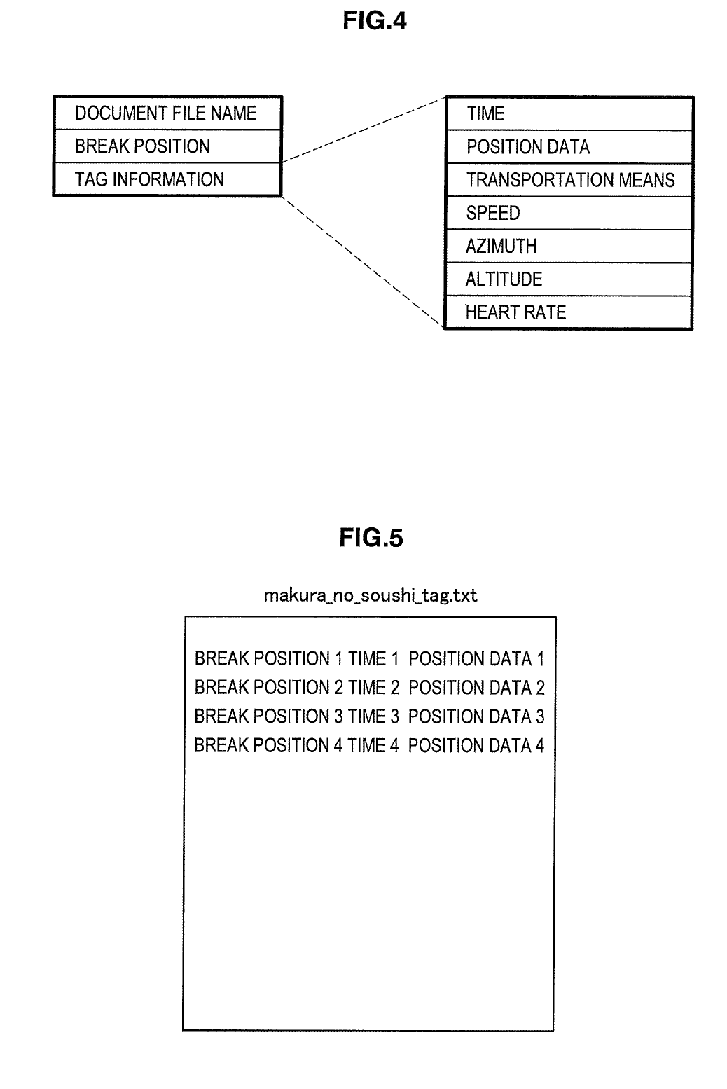

First, with reference to FIGS. 1 to 5, there will be described a functional configuration of the document creation device according to the first embodiment of the present disclosure. FIG. 1 is a block diagram showing a functional configuration of the document creation device according to the first embodiment of the present disclosure. FIG. 2 is an explanatory diagram showing an example of a document file created by the document creation device according to the embodiment. FIG. 3 is a table showing examples of break positions detected by the document creation device according to the embodiment. FIG. 4 is a table showing examples of items included in association information generated by the document creation device according to the embodiment. FIG. 5 is an explanatory diagram showing an example of an association information file generated by the document creation device according to the embodiment.

A document creation device 10a is an example of a tag information-assignment device 10 which assigns tag information to a plurality of locations in a file being created. For example, document creation device 10a may assign tag information to a plurality of break positions in the file being created. The document creation device 10a has a function of creating a document in accordance with an input, and also has a function of assigning tag information to each break of the created document. The document creation device 10a may be an information processing apparatus such as a mobile phone, a personal computer (PC), and a personal handyphone system (PHS). Alternatively, the document creation device 10a may also be an information processing apparatus such as a home game console, a household electrical appliance, a mobile music playback device, a mobile video processing device, and a mobile game console.

Note that, in the description below, among the tag information-assignment devices 10, an example of the tag information-assignment device 10 which assigns tag information to a document file is particularly referred to as document creation device 10a. Further, among the tag information-assignment device 10, an example of the tag information-assignment device 10 which assigns tag information to an audio file is particularly referred to as audio recording device 10b. However, when description is given on the items that are common to the document creation device 10a and the audio recording device 10b, they are each referred to as tag information-assignment device 10 as necessary.

The document creation device 10a mainly includes an input section 105, a document creation section 110, a break information acquisition section 115a, a position information acquisition section 120, a tag information acquisition section 125, an association information generation section 130, a storage section 135a, an output control section 140a, and an output section 145.

The input section 105 has a function of generating an input signal used by a user for performing a desired operation. For example, the input section 105 may be configured from an operation section for inputting information by the user, such as a touch sensor, a mouse, a keyboard, a button, a microphone, a switch, and a lever, and an input control circuit which generates and outputs an input signal based on the input by the user.

The document creation section 110 has a function of creating a document based on the input signal supplied from the input section 105. The document creation section 110 can supply at any time the break information acquisition section 115a with information of the created document. Further, the document creation section 110 can cause the storage section 135a to store the created document. Further, the document creation section 110 can supply the output control section 140a with the created document. Here, the following description will be given by using an example that a document file (file name: makura_no_soushi.txt) shown in FIG. 2 is created by the document creation section 110.

The break information acquisition section 115a has a function of detecting a break within one document file based on information of the input document. Here, the break information acquisition section 115a can detect a break position in accordance with a predetermined condition. FIG. 3 shows examples of positions of breaks to be detected here. For example, in some embodiments, a break position within the document may be a position of a line break within the document, a position of a punctuation mark (e.g., a period, a comma, etc.) within the document, a position of a word break within the document, a position of a clause within the document, and/or any other suitable break position. In this case, the break information acquisition section 115a can detect a break position by analyzing the input document, can generate break information indicating the break position, and can supply the tag information acquisition section 125 with the break information. Note that the break information acquisition section 115a can acquire, generally on a real-time basis, the document created by the document creation section 110 in accordance with the input using the input section 105. After that, the break information acquisition section 115a can notify, generally on a real-time basis, the tag information acquisition section 125 that the break position is detected. The break information acquisition section 115a can detect multiple break positions within one file.

The position information acquisition section 120 has a function of acquiring present position information. The position information acquisition section 120 may calculate the present position information based on positioning signals received from positioning satellites. In this case, the position information acquisition section 120 may be realized by a global positioning system (GPS) antenna and a GPS processing section which calculates position information from a GPS reception signal, for example. Alternatively, the position information acquisition section 120 may have a function of measuring a relative position using various types of sensors. Further, the position information acquisition section 120 may acquire the position information based on position estimation technology using Wi-Fi. For example, the position information acquisition section 120 may acquire an ID for identifying a nearby Wi-Fi access point, and may estimate the present position information by the neighborhood determination using the ID and information of reference database in which positions of access points are registered. Further, the position information acquisition section 120 may estimate, based on reception strengths of Wi-Fi radio waves received from multiple access points, distances between the respective access points and the tag information-assignment device 10, and may calculate the present position information based on the triangulation principle using the estimated distances and the pieces of position information of the access points. Further, the position information acquisition section 120 may acquire the position information based on various types of indoor positioning technology. Examples of the technology used for indoor positioning include an indoor messaging system (IMES) which is also referred to as indoor GPS, visible light communication, infrared data communication, a radio frequency identification (RFID) tag, and a quick response (QR) code.

The tag information acquisition section 125 has a function of acquiring tag information for a document file created by the document creation section 110. When a break position within the document file is detected by the break information acquisition section 115a, the tag information acquisition section 125 can acquire the tag information corresponding to the detected break position. For example, the tag information corresponding to the break position may be tag information at the time point at which the break position is detected. The tag information to be acquired here may include time tag information and position tag information, for example. Referring to FIG. 4, examples of the tag information are shown. Here, the tag information acquired by the tag information acquisition section 125 may include, in addition to the time tag information and the position tag information, information such as transportation means, speed, azimuth, altitude, heart rate, temperature, humidity, and brightness. The tag information acquisition section 125 inputs the acquired tag information and the input break information to the association information generation section 130.

The association information generation section 130 has a function of generating association information in which tag information, break information indicating the position having the tag information assigned thereto, and a file having the tag information assigned thereto are associated with one another. The association information generation section 130 can generate the association information including items shown in FIG. 4, for example. For example, FIG. 5 shows an example of association information to be generated. As shown in FIG. 5, the association information generation section 130 includes a file name of an original document file in a part of the file name of the association information, and thus can generate the association information including information of the document file name. In this case, with respect to the document file name of “makura_no_soushi.txt”, the association information file having the file name of “makura_no_soushi_tag.txt” is generated. Further, in this case, an example of association information including time and position data as the tag information is shown. The association information generation section 130 can cause the storage section 135a to store the association information file to be generated. Note that, although it has been described that the association information is generated as the association information file that is different from the document file, the present technology is not limited thereto. For example, the association information may also be generated as metadata of the document file. However, as shown here, when the association information is generated as the association information file that is different from the document file, there is an advantage in that an operation performed in a device not supporting the tag information is not disturbed.

The storage section 135a is a device for storing data, and can include a storage medium, a recording device for recording data in the storage medium, a reading device for reading out the data from the storage medium, and a deletion device for deleting the data recorded in the storage medium. Here, as the storage medium, there may be used a non-volatile memory such as a flash memory, a magnetoresistive random access memory (MRAM), a ferroelectric random access memory (FeRAM), a phase change random access memory (PRAM), and an electronically erasable and programmable read only memory (EEPROM), and a magnetic recording medium such as a hard disk drive (HDD). The storage section 135a can store the document file created by the document creation section 110a and the association information file generated by the association information generation section 130, for example.

The output control section 140a has a function of controlling an output for providing the user with information from the document creation device 10a. The output control section 140a can provide the user with information using a display screen or an audio output, for example. The output control section 140a is an example of a display control section which controls contents in the display screen of the output section 145. Further, the output control section 140a can have a function of an audio output control section. The output control section 140a can generate a display screen for providing the user with a sentence, a break position within the sentence, and tag information assigned to the break position, and can cause the output section 145 to display the display screen. Further, although not shown, the output control section 140a can also control contents in the display screen based on an input signal input from the input section 105. The output control section 140a can control a display of a display screen in which tag information is superimposed on a document file, for example. Further, the output control section 140a can perform a display showing a break position on a document file, for example. For example, when the user performs some sort of operation on the display showing the break position, the output control section 140a may display the tag information associated with the break position.

The output section 145 is an example of an output device, and may be a liquid crystal display (LCD) device, an organic EL (organic light emitting diode (OLED)) display device, or the like.

Heretofore, examples of functions of the document creation device 10a according to the present embodiment have been shown. Each of the above structural elements may be configured using general-purpose members or circuits, or may be configured using hardware specialized for the function of each structural element. Further, the function of each structural element may be realized by reading out, by an arithmetic unit such as a CPU (Central Processing Unit), a control program from the storage medium such as a ROM (Read Only Memory) or a RAM (Random Access Memory) that stores the control program in which procedures for realizing those functions are written, and by interpreting and executing the program. Therefore, the configuration to be used can be changed appropriately in accordance with the technical level each time when the embodiment is carried out. Examples of hardware configurations for realizing the functions of the document creation device 10a will be described below.

Note that there may be produced a computer program for realizing respective functions of the document creation device 10a according to the present embodiment as described above, and the computer program can be implemented in a personal computer or the like. Further, there can also be provided a computer-readable recording medium having the computer program stored therein. Examples of the recording medium may include a magnetic disk, an optical disc, a magneto-optical disk, and a flash memory. Further, the computer program may be distributed via a network, without using the recording medium, for example.

Further, some of the above-mentioned structural elements of the document creation device 10a according to the present embodiment may be omitted. Further, the document creation device 10a may have a configuration further including structural elements other than the above-mentioned structural elements.

[1-2. Example of Display Screen]

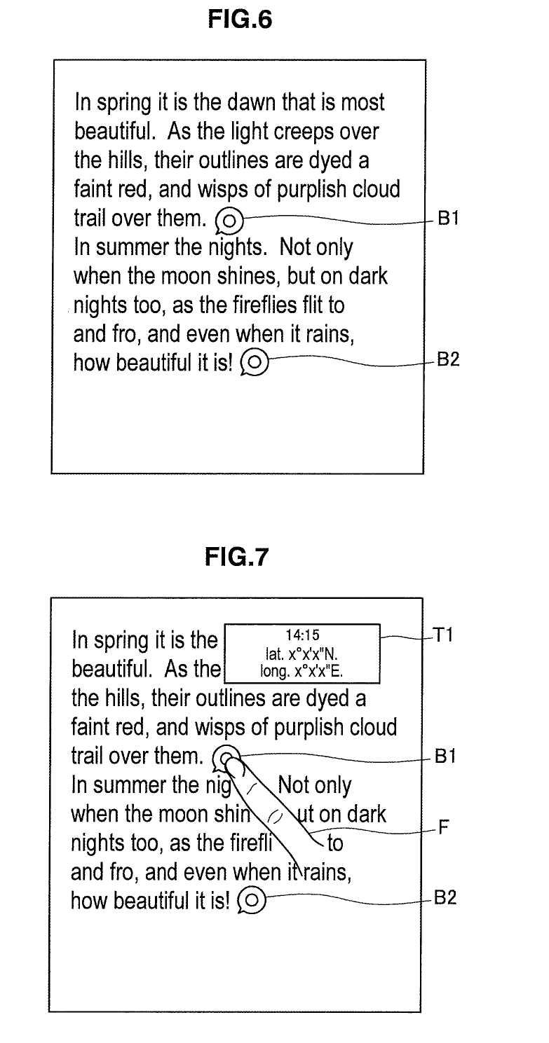

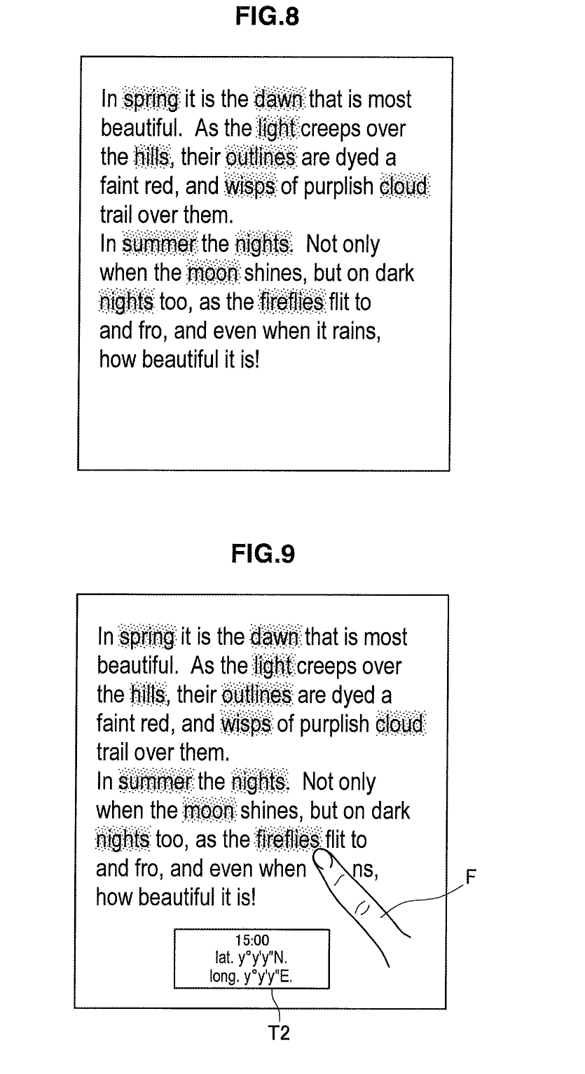

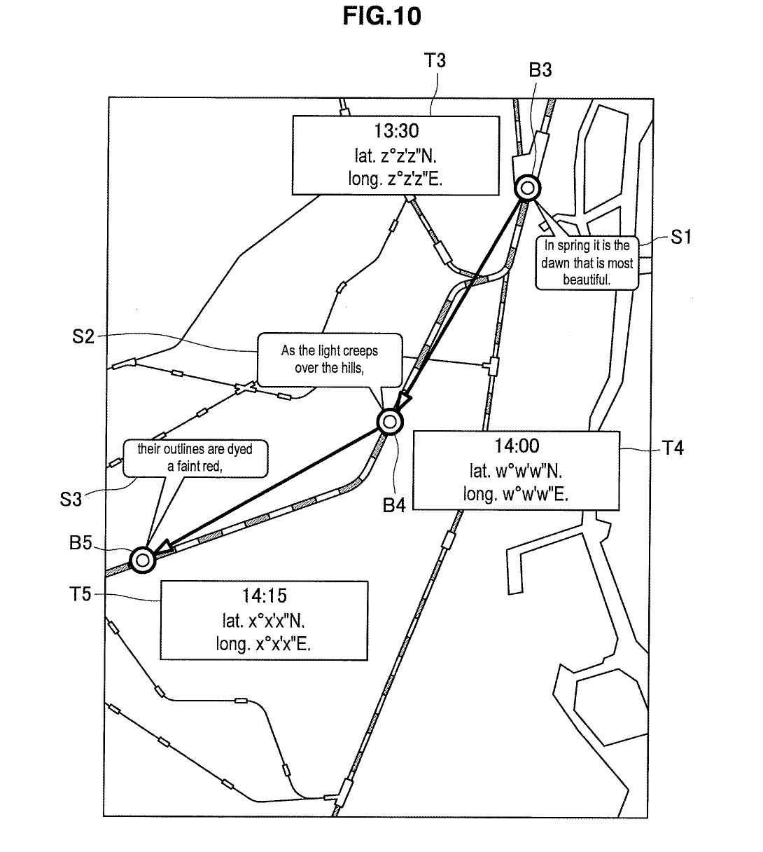

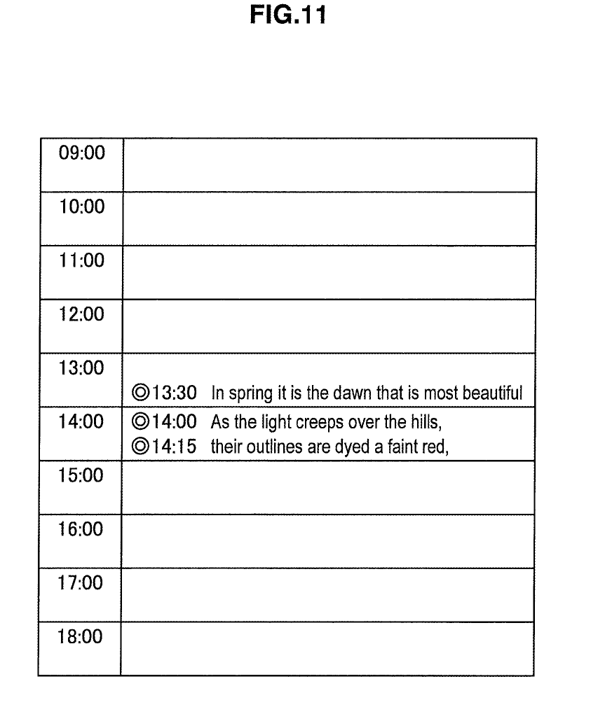

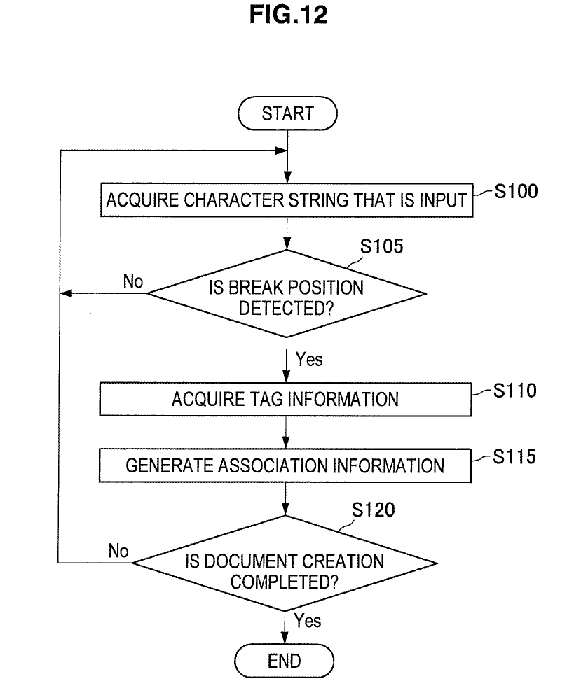

Next, with reference to FIGS. 6 to 11, examples of the display screen displayed by the document creation device according the first embodiment of the present disclosure will be described. FIG. 6 is an explanatory diagram showing an example of a display screen displayed by the document creation device according to the embodiment, which is for indicating positions having tags assigned thereto on sentences. FIG. 7 is an explanatory diagram showing an example of tag information which is displayed when an operation is performed on the display screen of FIG. 6. FIG. 8 is an explanatory diagram showing an example of the display screen displayed by the document creation device according to the embodiment, which is for indicating positions having the tags assigned thereto on the sentences when words are set as break positions. FIG. 9 is an explanatory diagram showing an example of the tag information which is displayed when an operation is performed on the display screen of FIG. 8. FIG. 10 is an explanatory diagram showing an example of a display screen in which tag information and sentences are displayed on a map by the document creation device according to the embodiment. FIG. 11 is an explanatory diagram showing an example of a display screen in which tag information and sentences are displayed on a calendar by the document creation device according to the embodiment.

For example, as shown in FIG. 6, the output control section 140a can cause a mark B indicating a break position to be displayed in a superimposed manner on a document created by the document creation section 110. FIG. 6 shows an example in which the line feed position is set as the break position. Here, as shown in FIG. 7, when the user operates with a finger F the mark B1 indicating a break position, the output control section 140a may cause tag information T1 to be displayed in a superimposed manner, for example. In this case, the tag information T1 includes time information and position information. Referring to the display, the user can find out that the sentences of “In spring it is the dawn that is most beautiful. As the light creeps over the hills, their outlines are dyed a faint red and wisps of purplish cloud trail over them.” are created at “14:15” at the position of “lat. x°x′x″N. and long. x°x′x″E.”

The tag information is acquired not for each document file but for each break position within the document file, and thus, a resolution of life log data can be enhanced. The user can find out in more detail the situation when a sentence is created, that is, the situation at the time point of expressing thoughts, idea, record, memorandum, and feelings. Here, there is shown an example in which the time and the position of the specific time point are recorded. However, the tag information recorded as described above is not limited to such an example. All pieces of information indicating the situation at that time point may be recorded as the tag information. For example, information of transportation means, speed, azimuth, altitude, heart rate, temperature, humidity, brightness, and the like may be recorded as the tag information.

Further, when the user performs an operation on the tag information T displayed in FIG. 7, the output control section 140a may cause a map display screen indicating the position information of the tag information to be displayed. The map display screen enables the user to visually grasp the position information that is assigned as the tag information. Further, although the position information has been shown in latitude and longitude on the sentences, the present technology is not limited thereto. For example, the position information may be shown by being displayed on a map that is superimposed on the sentences.

Note that, in each of the examples shown in FIG. 6 and FIG. 7, the tag information T is displayed when the operation on the mark B indicating the break position is detected. However, the present technology is not limited thereto. For example, the tag information may be displayed together with the sentences, regardless of presence/absence of detection of the operation. In this case, in order that the display of tag information does not disturb viewing of the sentences, the tag information may not be displayed in a superimposed manner on the sentences, and there may be provided a display area separately from the display area of the sentences.

Further, in the case where the break position represents a word break position, there may be shown the break position having a tag assigned thereto as shown in FIG. 8, for example. Here, an example is shown in which pieces of tag information are assigned to nouns in the sentences. The background of the word part having the tag information assigned thereto may be shown in different color in the sentence, or the word part having the tag information assigned thereto may be displayed in the manner that the word part is being encircled. Alternatively, the word part having the tag information assigned thereto may be displayed such that the word part flashes. Various expressions may be used. As shown in FIG. 9, when the user performs an operation with the finger F on the part having the tag shown in FIG. 8 assigned thereto, the output control section 140a may cause tag information T2 to be displayed, which is assigned to the part on which the operation is performed. Referring to the display, the user can grasp that the word “fireflies” is input at “15:00” at “lat. y° y′y″N. and long. y°y′y″E.″”

In some embodiments, the output control section 140a may cause tag information to be displayed on a map. Additionally, the output control section 140a may cause data associated with the tag information to be displayed on the map concurrently with the tag information. As one non-limiting example, FIG. 10 shows a map overlaid with multiple pieces of tag information (tag information T3, T4, and T5). In the illustrated example, each of the pieces of tag information is displayed concurrently with associated data. In particular, each of the pieces of tag information is displayed concurrently with sentences S1, S2, and S3, which were identified based at least in part on break positions B3, B4, and B5, respectively. Though, it should be appreciated that a piece of tag information may be displayed on a map without other data associated with the piece of tag information being concurrently displayed on the map, as aspects of the invention described herein are not limited in this respect. Note that the display screen shown in FIG. 10 may be a transition screen from the display screens shown in FIGS. 6 to 9.

Further, when time information is included in the tag information, the output control section 140a may cause the following to be displayed on a calendar as shown in FIG. 11: a time at which the tag information is assigned; and a sentence associated with the tag information. Here, it is desirable that the display granularity of the time axis of the calendar be changeable by an operation of the user. For example, although the calendar here is displayed on an hourly basis, it is desirable that the time axis may be changed to various units, such as on a day basis or on a monthly basis.

[1-3. Operation]

Next, with reference to FIG. 12, operation of the document creation device according to the first embodiment of the present disclosure will be described. FIG. 12 is a flowchart showing an operation example of the document creation device according to the embodiment.

First, the break information acquisition section 115a of the document creation device 10a acquires a character string that is input (S100). After that, the break information acquisition section 115a determines whether a break position is detected (S105). When the break position is detected, the tag information acquisition section 125 acquires tag information (S110). Then, the association information generation section 130 generates association information in which information of the break position detected in Step S105 and the tag information are associated with each other, and causes the storage section 135a to store the association information (S115).

Note that, in Step S110, the tag information acquisition section 125 can acquire time information and position information of a present point, for example. The character string which is input using the input section 105 is acquired each time and the break position is detected, and the position information of the present point and the time information at this break position are recorded in association with a sentence. In this way, the user can find out in detail the time and position information at which the sentence is created.

When the association information is generated, next, the document creation section 110 determines whether the document creation is completed (S120). In the case where it is determined in Step S120 that the creation of the document is not completed, the process of Step S100 is executed again. After that, the processes are repeated until it is determined in Step S120 that the creation of the document is completed.

Note that the description has been given on the case where the location corresponding to the break position represents the present position at the time point when the part corresponding to the break position within the sentence is being created. However, the location corresponding to the break position does not necessarily represent the present position. For example, the location corresponding to the break position may also represent the location expressed by the word indicated by the break position within the created sentence. To be specific, for example, when the word “ABC cake shop” is indicated by the break position, the tag information acquisition section 125 may acquire the position information of “ABC cake shop” using map information. In this case, it is not necessary that the position information be acquired during creation of the document.

### 2. Second Embodiment

### Example of Assigning Tag Information to Audio File

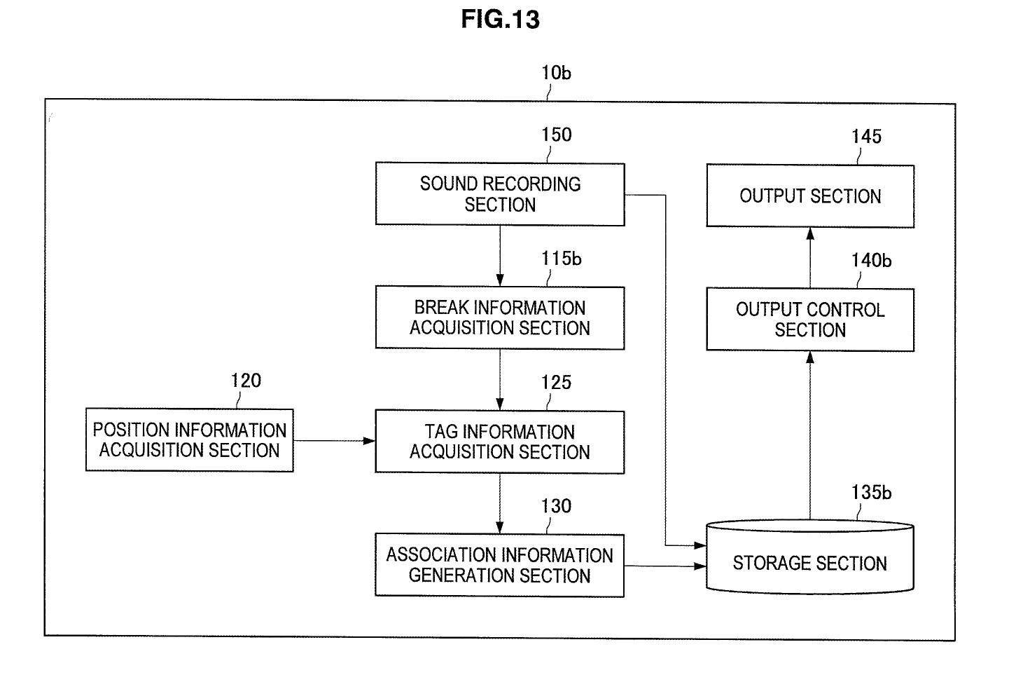

Next, with reference to FIGS. 13 to 16, an audio recording device according to a second embodiment of the present disclosure will be described. The audio recording device to be described here is an example of an information processing apparatus according to the present disclosure, and is an example of a tag information-assignment device that assigns tag information to an audio file.

[2-1. Functional Configuration]

First, with reference to FIG. 13, there will be described a functional configuration of the audio recording device according to the second embodiment of the present disclosure. FIG. 13 is a block diagram showing a functional configuration of the audio recording device according to the second embodiment of the present disclosure.

The audio recording device 10b is an example of a tag information-assignment device 10 which assigns tag information to each break of a file. The audio recording device 10b has a function of collecting sounds and can record the acquired audio. Further, the audio recording device 10b has a function of assigning tag information to each break of the acquired audio. The audio recording device 10b may be an information processing apparatus such as a mobile phone, a PC, a PHS, and a voice recorder. Alternatively, the audio recording device 10b may also be an information processing apparatus such as a home game console, a household electrical appliance, a mobile music playback device, a mobile video processing device, and a mobile game console.

Referring to FIG. 13, the audio recording device 10b mainly includes a sound recording section 150, a break information acquisition section 115b, a position information acquisition section 120, a tag information acquisition section 125, an association information generation section 130, a storage section 135b, an output control section 140b, and an output section 145.

Note that the structural elements that are the same as those of the document creation device 10a according to the first embodiment of the present disclosure are denoted with the same reference numerals, and repeated explanation of these structural elements is omitted. Hereinafter, description will be made mainly on the matters that are different from the document creation device 10a.

The sound recording section 150 has a function of collecting sounds and a function of recording the acquired audio. For example, the sound recording section 150 encodes, using an encoder, the audio collected using a microphone, and can record the encoded audio in the storage section 135b as digital audio data.

The break information acquisition section 115b has a function of detecting a break within one audio file based on the input audio data. Here, the break information acquisition section 115b can detect a break position in accordance with a predetermined condition. For example, the break position to be detected here may be a part at which the audio is interrupted. Further, the break position may be a part including a keyword that is decided in advance. The break information acquisition section 115b can perform audio recognition, and can detect the break position within the audio file.

The storage section 135b is a device for storing data, and can include a storage medium, a recording device for recording data in the storage medium, a reading device for reading out the data from the storage medium, and a deletion device for deleting the data recorded in the storage medium. Here, as the storage medium, there may be used a non-volatile memory such as a flash memory, a magnetoresistive random access memory (MRAM), a ferroelectric random access memory (FeRAM), a phase change random access memory (PRAM), and an electronically erasable and programmable read only memory (EEPROM), and a magnetic recording medium such as a hard disk drive (HDD). The storage section 135b can store the audio file created by the sound recording section 150 and the association information file generated by the association information generation section 130, for example.

The output control section 140b has a function of controlling an output for providing the user with information from the audio recording device 10b. The output control section 140b can provide the user with information using a display screen or an audio output, for example. The output control section 140b has a function of controlling contents in the display screen of the output section 145, for example. The output control section 140b can generate a map display screen indicating the position information at the time of creating the audio file, and can cause the output section 145 to display the map display screen. On the map display screen, tag information may be displayed in a superimposed manner. Further, the output control section 140b can also control contents in the display screen based on an input signal input from the input section 105. For example, on the map display screen which has a point having a tag assigned thereto on a map, when an operation to select the point is detected, the output control section 140b may output the audio associated with the point.

Heretofore, examples of functions of the audio recording device 10b according to the present embodiment have been shown. Each of the above structural elements may be configured using general-purpose members or circuits, or may be configured using hardware specialized for the function of each structural element. Further, the function of each structural element may be realized by reading out, by an arithmetic unit such as a CPU (Central Processing Unit), a control program from the storage medium such as a ROM (Read Only Memory) or a RAM (Random Access Memory) that stores the control program in which procedures for realizing those functions are written, and by interpreting and executing the program. Therefore, the configuration to be used can be changed appropriately in accordance with the technical level each time when the embodiment is carried out. Examples of hardware configurations for realizing the functions of the audio recording device 10b will be described below.

Note that there may be produced a computer program for realizing respective functions of the audio recording device 10b according to the present embodiment as described above, and the computer program can be implemented in a personal computer or the like. Further, there can also be provided a computer-readable recording medium having the computer program stored therein. Examples of the recording medium may include a magnetic disk, an optical disc, a magneto-optical disk, and a flash memory. Further, the computer program may be distributed via a network, without using the recording medium, for example.

Further, some of the above-mentioned structural elements of the audio recording device 10b according to the present embodiment may be omitted. Further, the audio recording device 10b may have a configuration further including structural elements other than the above-mentioned structural elements. For example, the audio recording device 10b includes a display section as the output section 145, but is not limited thereto. For example, the audio recording device 10b may not have a display function.

[2-2. Example of Display Screen]

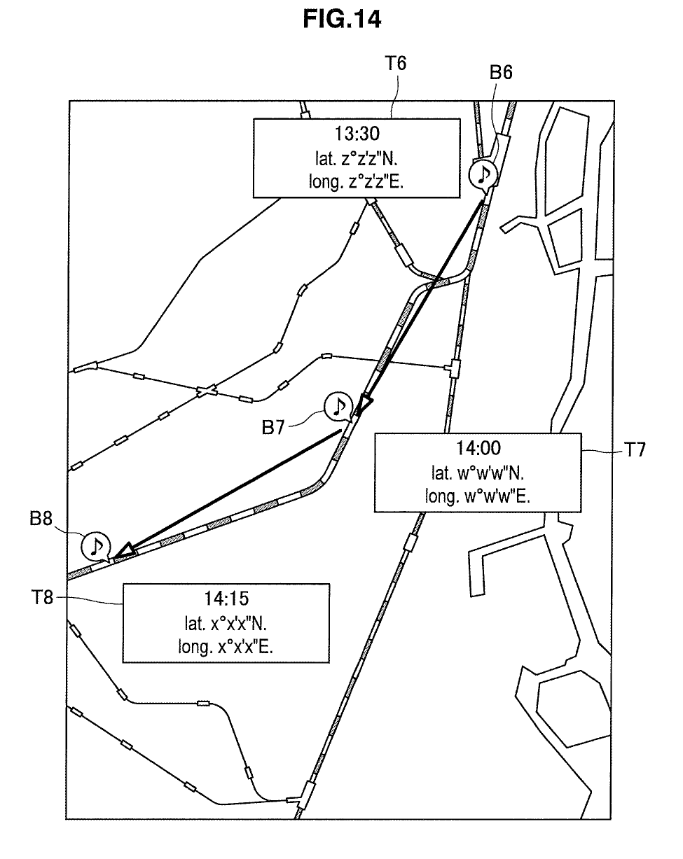

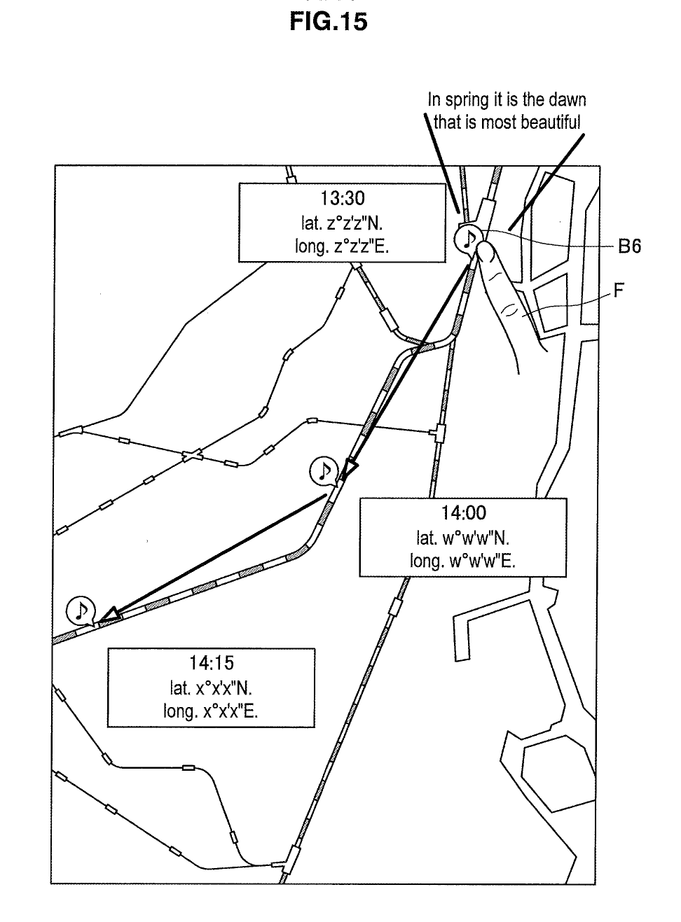

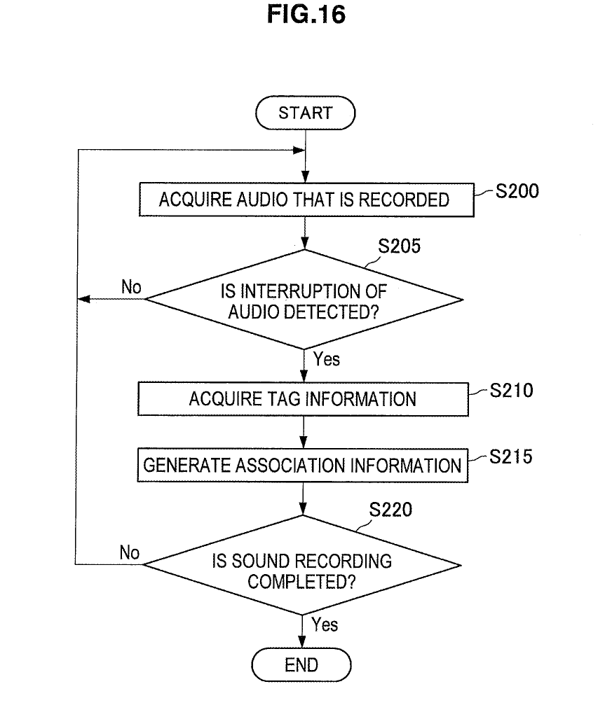

Next, with reference to FIGS. 14 and 15, examples of the display screen displayed by the audio recording device according the second embodiment of the present disclosure will be described. FIG. 14 is an explanatory diagram showing an example of a display screen displayed by the audio recording device according to the embodiment, which is for indicating a position having a tag during audio recording assigned thereto. FIG. 15 is an explanatory diagram showing a state when an operation is performed on the display screen of FIG. 14.

For example, as shown in FIG. 14, the output control section 140b can cause a map display screen to be displayed, which shows a location at which an audio is acquired on a map. On the map display screen, a location at which an audio is acquired is shown by a mark B. The mark B is superimposed on a position of a present point acquired at a break position within an audio file. The user refers to the map display screen, and thus can grasp that the acquired audio data is present at the point on which the mark B is superimposed. In FIG. 14, there are marks B (marks B6 to B8) each showing a break position at three points. Further, tag information T corresponding to the break position may also be shown.

When the user performs an operation with the finger F on one of the marks B shown in FIG. 14, for example, on the mark B6, the output control section 140b may cause the audio data associated with the mark B6 to be output (FIG. 15).

[2-3. Operation]

Next, with reference to FIG. 16, an operation of the audio recording device 10b according to the second embodiment of the present disclosure will be described. FIG. 16 is a flowchart showing an operation example of the audio recording device according to the embodiment.

First, the break information acquisition section 115b of the audio recording device 10b acquires audio data that is recorded (S200). After that, the break information acquisition section 115b determines whether an interruption of audio is detected (S205). Note that, although it is set here that the break position represents the part at which the audio is interrupted, the break position is not limited thereto. The break position may be detected in accordance with every predetermined condition.

When the break position (interruption of audio) is detected in Step S205, the tag information acquisition section 125 acquires tag information (S210). Then, the association information generation section 130 generates association information in which information of the break position detected in Step S205 and the tag information are associated with each other (S215).

Note that, in Step S210, the tag information acquisition section 125 can acquire time information and position information of a present point, for example. The audio data which is recorded by the sound recording section 150 is acquired each time and the break position is detected, and the position information of the present point and the time information at this break position are recorded in association with an audio. In this way, the user can find out in detail the time and position information at which the audio is acquired.

When the association information is generated, next, the sound recording section 150 determines whether the sound recording is completed (S220). In the case where it is determined in Step S220 that the sound recording is not completed, the process of Step S200 is executed again. After that, the processes are repeated until it is determined in Step S220 that the sound recording is completed.

Note that the description has been given on the case where the location corresponding to the break position represents the present position at the time point when the part corresponding to the break position within the audio file is being recorded. However, the location corresponding to the break position does not necessarily represent the present position. For example, the location corresponding to the break position may also represent the location expressed by the word indicated by the break position within the recorded audio. To be specific, for example, when the word “ABC cake shop” is detected as the break position by performing audio recognition, the tag information acquisition section 125 may acquire the position information of “ABC cake shop” using map information. In this case, it is not necessary that the position information be acquired during recording of the audio.

### 3. Third Embodiment

### Output Control Device

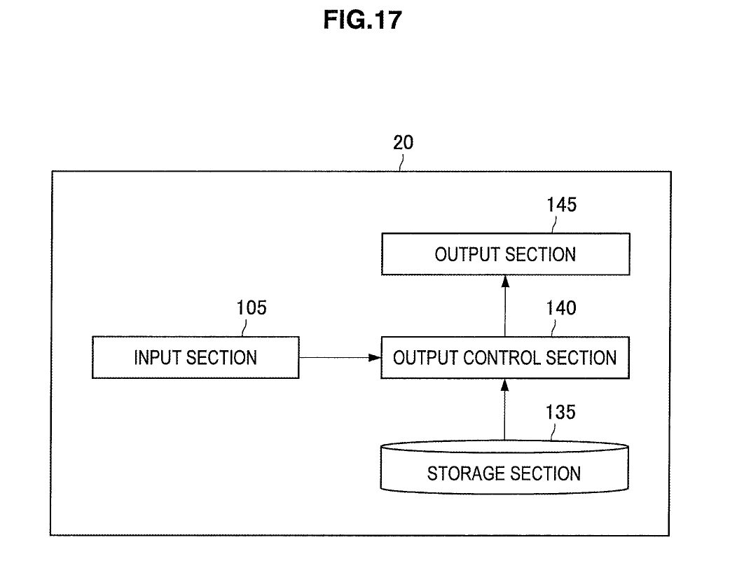

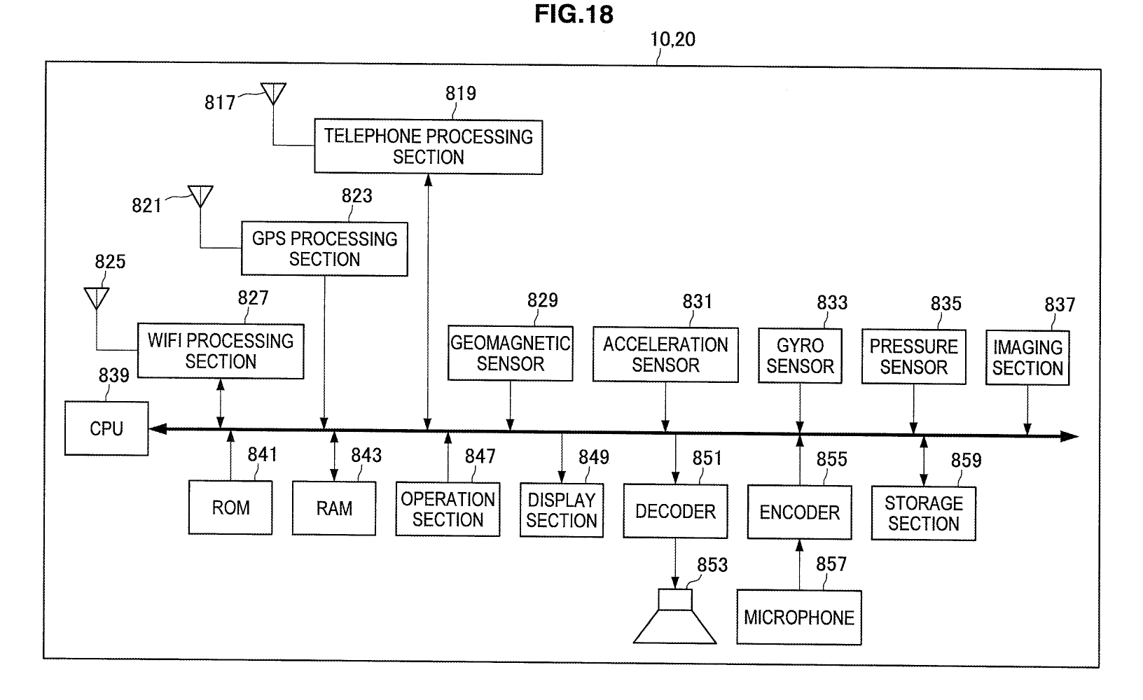

Next, with reference to FIG. 17, an output control device according to a third embodiment of the present disclosure will be described. FIG. 17 is a block diagram showing a functional configuration of the output control device according to the third embodiment of the present disclosure.

In the first embodiment, the description has been given on the document creation device 10a as an example of the tag information-assignment device that assigns tag information to a break position of a document file. Further, in the second embodiment, the description has been given on the audio recording device 10b as an example of the tag information-assignment device that assigns tag information to a break position of an audio file. The document creation device 10a and the audio recording device 10b each have a function of assigning the tag information, and also have a display control function for causing a display screen, which shows the tag information and the file, to be displayed. However, the tag information assigned by those tag information-assignment devices may be played back by an output control device which does not have the tag information-assignment function.

Accordingly, in the present embodiment, there will be described an output control device 20 which can control output of a document file and tag information generated by another device, or an audio file and tag information generated by another device.

Referring to FIG. 17, the output control device 20 mainly includes an input section 105, a storage section 135, an output control section 140, and an output section 145.

The output control device 20 can have at least one of the output control function of the document creation device 10a described in the first embodiment or the output control function of the audio recording device 10b described in the second embodiment. That is, the storage section 135 has at least one of the function of the storage section 135a or the function of the storage section 135b. Further, the output control section 140 has at least one of the function of the output control section 140a or the function of the output control section 140b.

Heretofore, examples of functions of the output control device 20 according to the present embodiment have been shown. Each of the above structural elements may be configured using general-purpose members or circuits, or may be configured using hardware specialized for the function of each structural element. Further, the function of each structural element may be realized by reading out, by an arithmetic unit such as a CPU (Central Processing Unit), a control program from the storage medium such as a ROM (Read Only Memory) or a RAM (Random Access Memory) that stores the control program in which procedures for realizing those functions are written, and by interpreting and executing the program. Therefore, the configuration to be used can be changed appropriately in accordance with the technical level each time when the embodiment is carried out. Examples of hardware configurations for realizing the functions of the output control device 20 will be described below.

Note that there may be produced a computer program for realizing respective functions of the output control device 20 according to the present embodiment as described above, and the computer program can be implemented in a personal computer or the like. Further, there can also be provided a computer-readable recording medium having the computer program stored therein. Examples of the recording medium may include a magnetic disk, an optical disc, a magneto-optical disk, and a flash memory. Further, the computer program may be distributed via a network, without using the recording medium, for example.

Further, some of the above-mentioned structural elements of the output control device 20 according to the present embodiment may be omitted. Further, the output control device 20 may have a configuration further including structural elements other than the above-mentioned structural elements.

### 4. Example of Hardware Configuration

Next, with reference to FIG. 18, there will be described hardware configuration examples of the tag information-assignment devices 10 and the output control device 20 according to the first to third embodiments of the present disclosure. FIG. 18 is a block diagram showing a hardware configuration example of the tag information-assignment devices and the output control device according to the embodiment. Note that the description will be given below of the hardware configuration of the tag information-assignment devices 10 (including the document creation device 10a and the audio recording device 10b). However, the hardware configuration of the output control device 20 is also be described by replacing the tag information-assignment device 10 with the output control device 20.

Here, an example of the configuration of the tag information-assignment device 10 will be described. Referring to FIG. 18, the tag information-assignment device 10 includes, for example, a telephone network antenna 817, a telephone processing section 819, a GPS antenna 821, a GPS processing section 823, a WiFi antenna 825, a WiFi processing section 827, a geomagnetic sensor 829, an acceleration sensor 831, a gyro sensor 833, a pressure sensor 835, an imaging section 837, a CPU (Central Processing Unit) 839, a ROM (Read Only Memory) 841, a RAM (Random Access Memory) 843, an operation section 847, a display section 849, a decoder 851, a speaker 853, an encoder 855, a microphone 857, and a storage section 859. Note that the hardware configuration shown here is merely an example, and some of the structural elements may be omitted. Further, the hardware configuration may of course include structural elements other than the above-mentioned structural elements.

### (Telephone Network Antenna 817)

The telephone network antenna 817 is an example of an antenna having a function of establishing a connection via radio waves with a mobile phone network for telephone call and data communication. The telephone network antenna 817 can supply the telephone processing section 819 with a telephone call signal received through the mobile phone network.

### (Telephone Processing Section 819)

The telephone processing section 819 has a function of performing various types of signal processing on a signal transmitted/received by the telephone network antenna 817. For example, the telephone processing section 819 can perform various types of processing on an audio signal which is input through the microphone 857 and encoded by the encoder 855, and can supply the telephone network antenna 817 with the audio signal. Further, the telephone processing section 819 can perform various types of processing on an audio signal supplied by the telephone network antenna 817, and can supply the decoder 851 with the audio signal.

### (GPS Antenna 821)

The GPS antenna 821 is an example of an antenna which receives a signal from a positioning satellite. The GPS antenna 821 is capable of receiving GPS signals from multiple GPS satellites, and inputs the received GPS signals to the GPS processing section 823.

### (GPS Processing Section 823)

The GPS processing section 823 is an example of a calculation section which calculates position information based on the signals received from the positioning satellites. The GPS processing section 823 calculates current position information based on the multiple GPS signals input from the GPS antenna 821, and outputs the calculated position information. To be specific, the GPS processing section 823 calculates positions of the respective GPS satellites based on the orbital data of the GPS satellites, and calculates distances from the respective GPS satellites to the tag information-assignment device 10 based on the differences between transmission time and reception time of the GPS signals. Then, based on the calculated positions of the respective GPS satellites and the calculated distances from the respective GPS satellites to the information-assignment device 10, a current three-dimensional position is calculated. Note that the orbital data of the GPS satellites used here may be included in the GPS signals, for example. Alternatively, the orbital data of the GPS satellites may be acquired from an external server through a communication antenna 825.

### (WiFi Antenna 825)

The WiFi antenna 825 is an antenna having a function of transmitting and receiving a communication signal to/from a wireless local area network (LAN) communication network in accordance with the WiFi specification, for example. The WiFi antenna 825 can supply the WiFi processing section 827 with the received signal.

### (WiFi Processing Section 827)

The WiFi processing section 827 has a function of performing various types of signal processing on the signal supplied by the WiFi antenna 825. The WiFi processing section 827 can supply the CPU 839 with a digital signal generated from the supplied analog signal.

### (Geomagnetic Sensor 829)

The geomagnetic sensor 829 is a sensor for detecting geomagnetism as a voltage value. The geomagnetic sensor 829 may be a 3-axis geomagnetic sensor which detects geomagnetism in the X-axis direction, the Y-axis direction, and the Z-axis direction. The geomagnetic sensor 829 can supply the CPU 839 with the detected geomagnetic data.

### (Acceleration Sensor 831)

The acceleration sensor 831 is a sensor for detecting acceleration as a voltage value. The acceleration sensor 831 may be a 3-axis acceleration sensor which detects acceleration along the X-axis direction, acceleration along the Y-axis direction, and acceleration along the Z-axis direction. The acceleration sensor 831 can supply the CPU 839 with the detected acceleration data.

### (Gyro Sensor 833)

The gyro sensor 833 is a measuring instrument for detecting an angle or an angular velocity of an object. The gyro sensor 833 may be a 3-axis gyro sensor which detects a variable velocity (angular velocity) of the rotation angle around each of the X-axis, the Y-axis, and the Z-axis as a voltage value. The gyro sensor 833 may supply the CPU 839 with the detected angular velocity data.

### (Pressure Sensor 835)

The pressure sensor 835 is a sensor for detecting the surrounding pressure as a voltage value. The pressure sensor 835 can detect a pressure at a predetermined sampling frequency, and can supply the CPU 839 with the detected pressure data. Note that the pressure sensor 835 is an example of a sensor for detecting a state of an environment around the tag information-assignment device 10. The tag information-assignment device 10 may further include a temperature sensor, a humidity sensor, and a brightness sensor, for example.

### (Imaging Section 837)

The imaging section 837 has a function of capturing a still image or a moving image via a lens in accordance with control of the CPU 839. The imaging section 837 may cause the storage section 859 to store the captured image.

### (CPU 839)

The CPU 839 functions as an arithmetic processing unit and a control unit, and controls the overall operation inside the tag information-assignment device 10 in accordance with various programs. Further, the CPU 839 may be a microprocessor. The CPU 839 can realize various functions in accordance with various programs.

### (ROM 841, RAM 843)

The ROM 841 can store programs and arithmetic parameters used by the CPU 839. The RAM 843 temporarily stores programs used during execution of the CPU 839 and parameters that appropriately change during the execution thereof.

### (Operation Section 847)

The operation section 839 has a function of generating an input signal used by a user for performing a desired operation. For example, the operation section 847 may be configured from, for example, an input section for inputting information by the user, such as a touch sensor, a mouse, a keyboard, a button, a microphone, a switch, and a lever, and an input control circuit which generates an input signal based on the input by the user and outputs the generated input signal to the CPU 839.

### (Display Section 849)

The display section 849 is an example of an output device, and may be a liquid crystal display (LCD) device, an organic EL (organic light emitting diode (OLED)) display device, or the like. The display section 849 displays a screen to the user, and thereby being able to provide information.

### (Decoder 851, Speaker 853)

The decoder 851 has a function of performing decoding, analog conversion, and the like of input data in accordance with the control of the CPU 839. The decoder 851 can perform decoding, analog conversion, and the like of audio data input through the telephone network antenna 817 and the telephone processing section 819, and can output an audio signal to the speaker 853, for example. Further, the decoder 851 can perform decoding, analog conversion, and the like of audio data input through the WiFi antenna 825 and the WiFi processing section 827, and can output an audio signal to the speaker 853, for example. The speaker 853 can output the audio based on the audio signal supplied from the decoder 851.

### (Encoder 855, Microphone 857)

The encoder 855 has a function of performing digital conversion, encoding, and the like of input data in accordance with the control of the CPU 839. The encoder 855 can perform digital conversion, encoding, and the like of an audio signal input from the microphone 857, and can output audio data. The microphone 857 can collect audio and output the audio as an audio signal.

### (Storage Section 859)

The storage section 859 is a device for storing data, and can include a storage medium, a recording device for recording data in the storage medium, a reading device for reading out the data from the storage medium, and a deletion device for deleting the data recorded in the storage medium. Here, as the storage medium, there may be used a non-volatile memory such as a flash memory, a magnetoresistive random access memory (MRAM), a ferroelectric random access memory (FeRAM), a phase change random access memory (PRAM), and an electronically erasable and programmable read only memory (EEPROM), and a magnetic recording medium such as a hard disk drive (HDD).

It should be understood by those skilled in the art that various modifications, combinations, sub-combinations and alterations may occur depending on design requirements and other factors insofar as they are within the scope of the appended claims or the equivalents thereof.

For example, in some embodiments, at least a part of functionality performed by a device (e.g., document creation device 10a, audio recording device 10b, output control device 10c, etc.) may be performed by at least one other processor or processors remote from the device, but communicatively coupled to the device. As such, in some embodiments, functionality performed by a device may be performed only on the device, only on one or more remote processors communicatively coupled from the device, or at least in part by the device and at least in part by the remote processor(s) communicatively coupled to the device. The remote processor(s) may be any suitable processor(s) and, for example, may comprise at least one server and/or be part of a cloud computing system.

For example, in some embodiments, a device (e.g., document creation device 10a, audio recording device 10b, output control device 10c, etc.) may be configured to perform the acts of: (A) identifying, while a file is being created, a plurality of locations within the file, the plurality of locations including a first location within the file and a second location within the file different from the first location; (B) acquiring first tag information for the first location within the file and second tag information for the second location within the file; and (C) associating the first tag information with the first location within the file and the second tag information with the second location within the file. In other embodiments, a device may be communicatively coupled to one or more remote processors (e.g., a cloud computing system, a server, etc.) and the remote processor(s) may at least partially perform one or more of acts (A), (B), and/or (C). Thus, in some embodiments, a system comprising a device and one or more processors communicatively coupled to the device may perform one or more of acts (A), (B), and/or (C), with the device at least partially performing on or more of acts (A), (B), and/or (C) and the remote processor(s) at least partially performing one or more acts (A), (B), and/or (C). It should be appreciated, that a system comprising a device and one or more remote processors communicatively coupled to the device is not limited to performing acts (A), (B), and/or (C), and may be configured to perform any previously described functionality performed by any previously described device (e.g., document creation device 10a, audio recording device 10b, output control device 10c, etc.), as aspects of the invention described herein are not limited in this respect.

Another example of a modification of the above-described embodiments is that, although the embodiments described above used GPS as an example of the positioning satellite, the positioning satellite is not limited to being a GPS satellite. The positioning satellite may be various types of positioning satellites such as Galileo, GLONASS, COMPASS, and MICHIBIKI. In this case, one type of positioning satellite may be used, or positioning signals obtained from multiple types of satellites may be used in combination. The configuration to be used for acquiring position information can be changed appropriately in accordance with the technical level each time when the embodiment is carried out.

Note that in the present specification, the steps written in the flowchart may of course be processed in chronological order in accordance with the stated order, but may not necessarily be processed in the chronological order, and may be processed individually or in a parallel manner. It is needless to say that, in the case where the steps are processed in the chronological order, the order of the steps may be changed appropriately according to circumstances.

Additionally, the present technology may also be configured as below.

(1) A system for creating files, the system comprising:

at least one processor configured to:
identify, while a file is being created, a plurality of locations within the file, the plurality of locations including a first location within the file and a second location within the file different from the first location;
acquire first tag information for the first location within the file and second tag information for the second location within the file; and
associate the first tag information with the first location within the file and the second tag information with the second location within the file.
   (2) The system of (1), wherein the at least one processor is configured to identify the plurality of locations within the file by identifying a first break position in the file as the first location and a second break position in the file as the second location.
   (3) The system of (2), wherein the first break position is a position selected from the group consisting of a position of a line break, a position of a punctuation mark, a position of a word break, and a position of a clause.
   (4) The system of (1), wherein the at least one processor is configured to acquire the first tag information at a first time when the at least one processor identifies the first location within the file.
   (5) The system of (4), wherein the at least one processor is configured to acquire the second tag information at a second time, when the at least one processor identifies the second location within the file, wherein the first time is different from the second time.
   (6) The system of (4), wherein the at least one processor comprises at least a first processor of a user's device, and wherein the at least one processor is configured to acquire first tag information for the first location within the file at least in part by acquiring information about a position of the user's device at the first time.
   (7) The system of (4), wherein the first location within the file is a break position in the file.
   (8) The system of (1), wherein the first tag information is different from the second tag information.
   (9) The system of (1), wherein the at least one processor comprises at least a first processor of a user's device, and wherein the first tag information comprises at least one of a time when the at least one processor identified the first location within the file and/or position information of the user's device at the first time.
   (10) The system of (1), wherein the at least one processor is configured to associate the first tag information with the first location within the file at least in part by storing the first tag information within the file.
   (11) The system of (1), wherein the file is being created based at least in part on input of a user and the at least one processor is configured to identify the plurality of locations based at least in part on the input of the user.
   (12) The system of (1), wherein the at least one processor is further configured to display first tag information to a user.
   (13) The system of (12), wherein the at least one processor is further configured to display first tag information to the user in response to input from the user identifying the first location within the file.
   (14) The system of (12), wherein the at least one processor comprises at least a first processor of a user's device, wherein the first tag information comprises information about a position of the user's device, and wherein the at least one processor is configured to display the first tag information to the user at least in part by displaying the position of the user's device on a map.
   (15) The system of (12), wherein the first tag information comprises information about a time when the at least one processor identified the first location within the file, and wherein the at least one processor is configured to display the first tag information to the user at least in part by displaying the time on a calendar.
   (16) The system of (1), wherein the system comprises a device and a cloud computing system, wherein the at least one processor comprises a first processor and a second processor, wherein the device comprises at least the first processor and the cloud computing system comprises at least the second processor, wherein the cloud computing system is configured to perform at least one of acts (A), (B), and/or (C).
   (17) The system of (1), wherein the system comprises a device comprising the at least one processor.
   (18) The system of (1), wherein the file is an audio file.
   (19) A method for creating files, the method comprising:
identifying by using at least one processor, while a file is being created, a plurality of locations within the file, the plurality of locations including a first location within the file and a second location within the file different from the first location;
acquiring first tag information for the first location within the file and second tag information for the second location within the file; and
associating the first tag information with the first location within the file and the second tag information with the second location within the file.
   (20) At least one computer-readable storage medium storing processor-executable instructions that, when executed by at least one processor, cause the at least one processor to perform a method comprising:
identifying, while a file is being created, a plurality of locations within the file, the plurality of locations including a first location within the file and a second location within the file different from the first location;
acquiring first tag information for the first location within the file and second tag information for the second location within the file; and
   associating the first tag information with the first location within the file and the second tag information with the second location within the file.

Some embodiments may comprise a non-transitory computer-readable storage medium (or multiple computer-readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage media) encoded with one or more programs (e.g., a plurality of processor-executable instructions) that, when executed on one or more computers or other processors, perform methods that implement the various embodiments discussed above. As is apparent from the foregoing examples, a non-transitory computer-readable storage medium may retain information for a sufficient time to provide computer executable instructions in a non-transitory form.

It should be understood by those skilled in the art that various modifications, combinations, sub-combinations and alterations may occur depending on design requirements and other factors insofar as they are within the scope of the appended claims or the equivalents thereof.

Use of ordinal terms such as “first,” “second,” “third,” etc., in the claims to modify a claim element does not by itself connote any priority, precedence, or order of one claim element over another or the temporal order in which acts of a method are performed. Such ordinal terms are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The present disclosure contains subject matter related to that disclosed in Japanese Priority Patent Application JP 2011-230983 filed in the Japan Patent Office on Oct. 20, 2011, the entire content of which is hereby incorporated by reference.

What is claimed is:

1. A system for creating files, the system comprising:
at least one processor configured to:
(A) identify, while a file is being created, a plurality of locations within the file, the plurality of locations including a first location within the file and a second location within the file different from the first location;
(B) acquire first tag information for the first location within the file and second tag information for the second location within the file; and
(C) associate the first tag information with the first location within the file and the second tag information with the second location within the file.

2. The system of claim 1, wherein the at least one processor is configured to identify the plurality of locations within the file by identifying a first break position in the file as the first location and a second break position in the file as the second location.

3. The system of claim 2, wherein the first break position is a position selected from the group consisting of a position of a line break, a position of a punctuation mark, a position of a word break, and a position of a clause.

4. The system of claim 1, wherein the at least one processor is configured to acquire the first tag information at a first time when the at least one processor identifies the first location within the file.

5. The system of claim 4, wherein the at least one processor is configured to acquire the second tag information at a second time, when the at least one processor identifies the second location within the file, wherein the first time is different from the second time.

6. The system of claim 4, wherein the at least one processor comprises at least a first processor of a user's device, and wherein the at least one processor is configured to acquire first tag information for the first location within the file at least in part by acquiring information about a position of the user's device at the first time.

7. The system of claim 4, wherein the first location within the file is a break position in the file.

8. The system of claim 1, wherein the first tag information is different from the second tag information.

9. The system of claim 1, wherein the at least one processor comprises at least a first processor of a user's device, and wherein the first tag information comprises at least one of a time when the at least one processor identified the first location within the file and/or position information of the user's device at the first time.

10. The system of claim 1, wherein the at least one processor is configured to associate the first tag information with the first location within the file at least in part by storing the first tag information within the file.

11. The system of claim 1, wherein the file is being created based at least in part on input of a user and the at least one processor is configured to identify the plurality of locations based at least in part on the input of the user.

12. The system of claim 1, wherein the at least one processor is further configured to display first tag information to a user.

13. The system of claim 12, wherein the at least one processor is further configured to display first tag information to the user in response to input from the user identifying the first location within the file.

14. The system of claim 12, wherein the at least one processor comprises at least a first processor of a user's device, wherein the first tag information comprises information about a position of the user's device, and wherein the at least one processor is configured to display the first tag information to the user at least in part by displaying the position of the user's device on a map.

15. The system of claim 12, wherein the first tag information comprises information about a time when the at least one processor identified the first location within the file, and wherein the at least one processor is configured to display the first tag information to the user at least in part by displaying the time on a calendar.

16. The system of claim 1, wherein the system comprises a device and a cloud computing system, wherein the at least one processor comprises a first processor and a second processor, wherein the device comprises at least the first processor and the cloud computing system comprises at least the second processor, wherein the cloud computing system is configured to perform at least one of acts (A), (B), and/or (C).

17. The system of claim 1, wherein the system comprises a device comprising the at least one processor.

18. The system of claim 1, wherein the file is an audio file.

19. A method for creating files, the method comprising:
identifying by using at least one processor, while a file is being created, a plurality of locations within the file, the plurality of locations including a first location within the file and a second location within the file different from the first location;
acquiring first tag information for the first location within the file and second tag information for the second location within the file; and
associating the first tag information with the first location within the file and the second tag information with the second location within the file.

20. At least one computer-readable storage medium storing processor-executable instructions that, when executed by at least one processor, cause the at least one processor to perform a method comprising:
identifying, while a file is being created, a plurality of locations within the file, the plurality of locations including a first location within the file and a second location within the file different from the first location;
acquiring first tag information for the first location within the file and second tag information for the second location within the file; and
associating the first tag information with the first location within the file and the second tag information with the second location within the file.
